(19) United States
(12) Patent Application Publication
(10) Pub. No.: US 2007/0281606 A1
(43) Pub. Date: Dec. 6, 2007

(54) Systems and methods for acquiring songs or products associated with radio broadcasts

(76) Inventor: Jeremiah J. Baunach, Seattle, WA (US)

Correspondence Address: Jeremiah J. Baunach, 1314 Coyote Path, San Antonio, TX, 78258, US

(21) Appl. No.: 11/443,589

(22) Filed: May 30, 2006

(51) Int. Cl. H04H 7/00

(52) U.S. Cl. 455/3.06

(57) ABSTRACT

A system for acquiring songs or products associated with radio broadcasts comprises means for indicating a selection of a product identified by metadata, the metadata included in a received radio broadcast. Also included is means for communicating to a computing device, triggered by said indicating a selection, the metadata identifying the product, said communicating enabling subsequent downloading or ordering of the product over a computer network using the metadata communicated to the computing device.

### BACKGROUND

Often while listening to the radio, such as on a car stereo system, a song comes on that one would like to purchase, but the title and artist of the song are not provided, or if they are, it may be difficult at that moment to write down or remember the song title and artist. If one does remember or write down the song title and artist, then one must take the time and effort to follow up and research to find the song in the music store or on the Internet, and then purchase the song. This process is time consuming, cumbersome and often gets interrupted or is not completed at all, resulting in a potential sale of a song being lost or delayed.

Also, consumers may wish to purchase other products associated with radio broadcasts such as those products that are the subject of radio advertisements. These products may be available for downloading over the Internet or ordering over the Internet, for example. However, the advertisements and products associated therewith are often forgotten soon after the advertisement or broadcast is over, or the information needed to acquire the product is not recorded, forgotten by the listener, or actions to follow up on the purchase are never taken by the listener. This may occur even though the listener may have been willing to purchase the product at the time of hearing the broadcast or advertisement.

Thus, needed are processes and a system that addresses the shortcomings of the prior art.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In consideration of the above-identified shortcomings of the art, systems and methods for a acquiring songs or products associated with radio broadcasts are provided. For several embodiments a system for acquiring songs or products associated with radio broadcasts comprises means for indicating a selection of a product identified by metadata, the metadata included in a received radio broadcast. Also included is means for communicating to a computing device, triggered by said indicating a selection, the metadata identifying the product, said communicating enabling subsequent downloading or ordering of the product over a computer network using the metadata communicated to the computing device.

A device for acquiring songs or products associated with radio broadcasts comprises a memory that stores, triggered by an indication of a product selection, metadata included in a radio broadcast identifying the product. A module of the device initiates a downloading or ordering process for the product over a computer network using the stored metadata.

Other advantages and features of the invention are described below.

### BRIEF DESCRIPTION OF THE DRAWINGS

Systems and methods for acquiring songs or products associated with radio broadcasts are further described with reference to the accompanying drawings in which:

FIG. 1 is a block diagram representing an exemplary computing device suitable for use in conjunction with providing systems and methods for transactions over radio;

FIG. 2 illustrates an exemplary networked computing environment in which many computerized processes may be implemented to provide systems and methods for transactions over radio;

FIG. 3 is a diagram illustrating an example of a system for collecting information broadcast over the radio with a portable computing device connected wirelessly to the radio;

FIG. 4 is a diagram illustrating an example of a system for acquiring songs or products whose information was collected through radio broadcast;

FIG. 5 is a diagram illustrating an example process for acquiring songs whose information was collected through radio broadcast;

FIG. 6 is a diagram illustrating an example process for acquiring products associated with an advertisement whose information was collected through radio broadcast;

FIG. 7 is a diagram illustrating a more detailed example process for ordering or downloading songs or products whose information was collected through radio broadcast and stored in a list;

FIG. 8 is a diagram illustrating an example of a system for collecting information broadcast over the radio with a portable computing device connected wirelessly to the radio;

FIG. 9 is a diagram illustrating an example of a system for collecting information broadcast over the radio wherein a portable computing device having a buy button is connected wirelessly to the radio;

FIG. 10 is a diagram illustrating an example of a system for acquiring songs or products whose information was collected through radio broadcast wherein a portable computing device is wirelessly connected to a computer;

FIG. 11 is a diagram illustrating an example of a system for acquiring songs or products associated with radio broadcasts; and

FIG. 12 is a diagram illustrating an example process for acquiring songs or products associated with radio broadcasts using a system such as that shown in FIG. 11.

### DETAILED DESCRIPTION

Certain specific details are set forth in the following description and figures to provide a thorough understanding of various embodiments of the invention. Certain well-known details often associated with computing and software technology are not set forth in the following disclosure to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

### Example Computing Environments

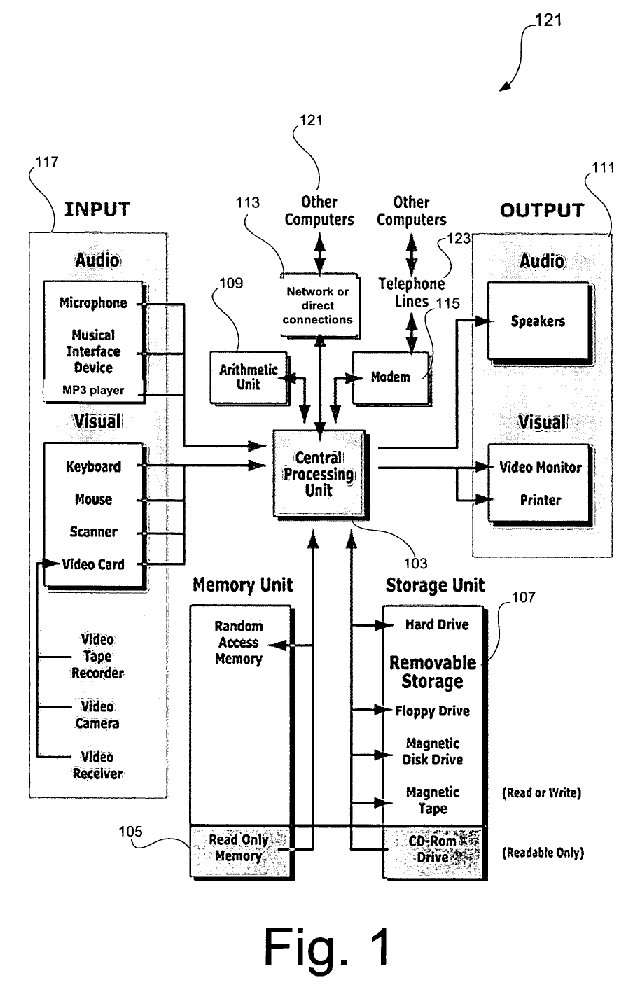

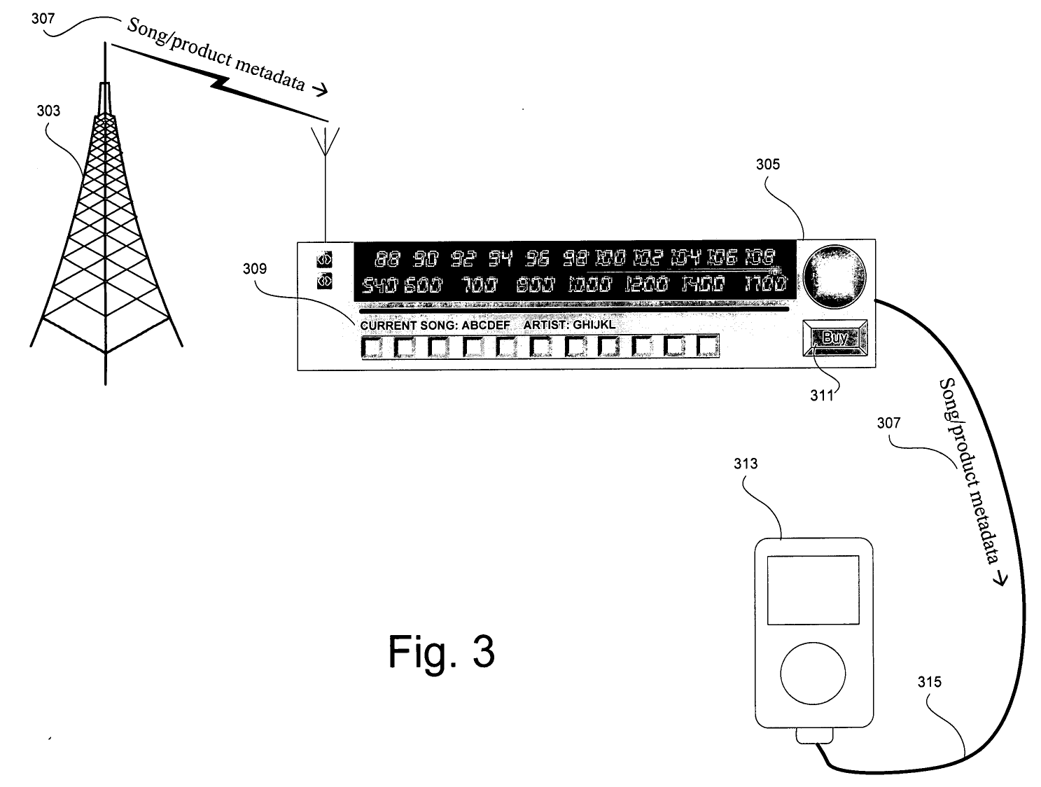

Referring to FIG. 1, shown is a block diagram representing an exemplary computing device suitable for use in conjunction with implementing the processes described above. For example, the computer executable instructions that carry out the processes and methods for acquiring songs or products associated with radio broadcasts may reside and/or be executed in such a computing environment as shown in FIG. 1. As a particular example, the portable computing device and/or the internet-connected computing device of FIGS. 3 through 12 may include the computing hardware and/or software shown and described below with reference to FIG. 1 in order to provide systems for and/or perform the methods for acquiring songs or products associated with radio broadcasts. The computing system environment 101 is only one example of a suitable computing environment and is not intended to suggest any limitation as to the scope of use or functionality of the invention. Neither should the computing environment 101 be interpreted as having any dependency or requirement relating to any one or combination of components illustrated in the exemplary operating environment 101. For example, a portable computing device may also include some or all of those items such as those described below for use in conjunction with implementing the processes described above.

Aspects of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be implemented in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An exemplary system for implementing aspects of the invention includes a general purpose computing device in the form of a computer or computing environment 101. The central processing unit (CPU) 103 receives information in the form of electronic impulses, and reroutes it to other parts of the computer 101. These impulses are simply electronic on/off switches. Ultimately, all the information a computer 101 receives, stores, manipulates, and sends is simply electronic impulses that are either “on”—there is an electrical charge stored in a particular place in the computer—or “off”—the relevant location in the computer does not have an electrical charge. The CPU 103 does handles a large number of operations in a very short period of time, about a billion operations per second on the most recent generation of computers.

Another important function of the computer 101 is the simple storage and retrieval of electronic impulses in what is called the memory unit 105 of the computer. The memory unit 105 stores the electronic impulses so that they can be retrieved by the central processing unit 105 at a later time.

There are different types of memory in computers. Random access memory, or RAM, is basically short-term memory that's stored in such a way that it's immediately accessible to the central processing unit. In most computers, the electronic impulses in RAM must be constantly recharged. Think of RAM as live electricity flowing through the system. Turn off the computer, and the flow of electricity ceases—the information stored in RAM disappears. This form of memory is very good for information one wants to access and process very quickly.

For that longer-term memory, one needs some form of storage unit that will reliably retain the information well after the computer 101 itself is turned off. One storage device is a hard drive 107, which basically records a copy of the electronic impulses on platters that spin within the computer 101. Other storage devices are magnetic tapes or floppy drives, magnetic disks or optical disks, or CD-ROMs, DVD's all of which store the information on a separate medium that can be removed from the computer and reinserted at a later time, or can be transferred to other computers to share the information encoded on them.

Some information is so critical to the operation of the computer that one wants it always to be accessible, and not normally altered. Such critical information is usually contained in a permanent storage unit known as read-only memory, or ROM. Think of ROM as the hard-wired circuits that can not normally be changed by the user of the computer. (You might notice that the line between computer memory and storage is not at all a fine one. For reasons that may be more historical than functional, read-only memory and random access memory are usually considered memory units, while hard drives and removable media are usually considered storage.)

Other parts of the computer are the arithmetic unit 109, which can add, subtract, multiply, divide, and perform other advanced calculations; input devices 117, such as a keyboard, a mouse, a microphone, a midi (musical interface device), a portable computing device, or various devices that allow the computer to communicate with peripheral and other computing devices, to recognize video images from a television receiver or video camera or video recorder; output devices 111, such as a computer monitor, a printer, or speakers; and connections to allow the computer to communicate with other computers or portable computing devices through direct connections 113 (such as including but not limited to: Ethernet, Universal Serial Bus (USB), Firewire®, wireless connections, Bluetooth®, etc.) 113 or over telephone lines 115 with a modem 115. Once computers 121 can access telephone or other long-distance lines 123, they can be linked via global networks like the Internet, so that practically any computer can access any other computer, wherever located.

Although exemplary embodiments may refer to utilizing aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

In light of the diverse computing environments that may be built according to the general framework provided in FIG. 1, the systems and methods provided herein cannot be construed as limited in any way to a particular computing architecture. Instead, the invention should not be limited to any single embodiment, but rather should be construed in breadth and scope in accordance with the appended claims.

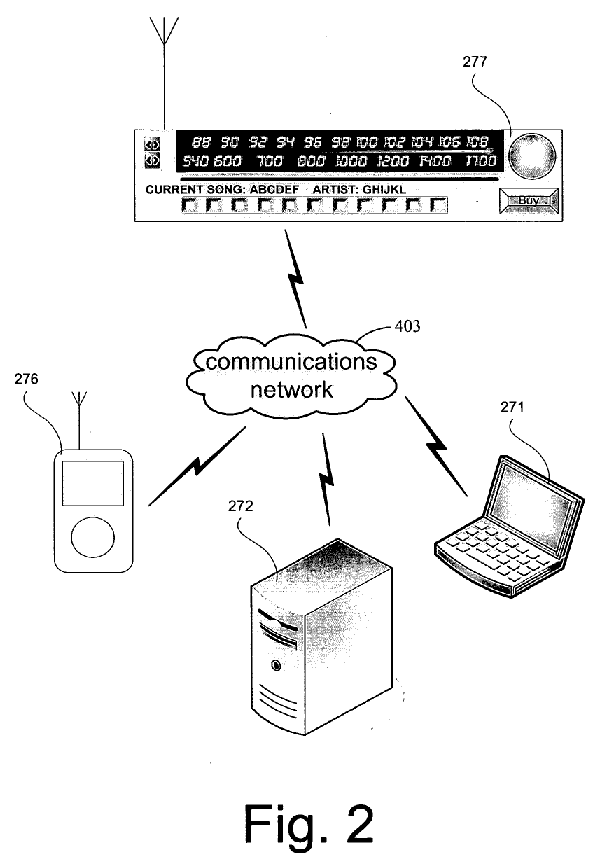

Referring next to FIG. 2, shown is an exemplary networked computing environment in which many computerized processes may be implemented to perform the processes described above. For example, parallel computing may be part of such a networked environment with various clients on the network of FIG. 2 using and/or implementing the processes for acquiring songs or products associated with radio broadcasts. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 2 provides a schematic diagram of an exemplary networked or distributed computing environment. The environment comprises computing devices 271, 272, 276, and radio 277 having a network interface. Each of these entities 271, 272, 276, and radio 277 may comprise or make use of programs, methods, data stores, programmable logic, etc. The entities 271, 272, 276, and radio 277 may span portions of the same or different devices such as portable computing devices including, but not limited to: PDAs, audio/video devices, MP3 players, personal computers, etc. Each entity 271, 272, 276, and radio 277, for example, may communicate with one or more of the other entities 271, 272, 276, and radio 277 by way of the communications network 403 (such as a computer network, for example). In this regard, any entity may be responsible for the maintenance and updating of a database or other storage element.

This network 403 may itself comprise other computing entities that provide services to the system of FIG. 2, and may itself represent multiple interconnected networks. In accordance with an aspect of the invention, each entity 271, 272, 276, and radio 277 may contain discrete functional program modules that might make use of an application programming interface (API), or other object, software, firmware and/or hardware, to request services of one or more of the other entities 271, 272, 276, and radio 277.

It can also be appreciated that an object, such as 276, may be hosted on another computing device 271. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, common object model (COM) objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2, any entity 271, 272, 276, and radio 277 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 2 and the further diversification that can occur in computing in a network environment such as that of FIG. 2, the systems and methods provided herein cannot be construed as limited in any way to a particular computing architecture or operating system. Instead, the invention should not be limited to any single embodiment, but rather should be construed in breadth and scope in accordance with the appended claims.

### Acquiring Song/Product Metadata

Referring to FIG. 3, shown is a diagram illustrating an example of a system for collecting information broadcast over the radio with a portable computing device connected wirelessly to the radio. A radio broadcast signal 301 is sent from radio station tower 303 and received at radio receiver 305. Included in the broadcast is metadata 307 associated with the particular broadcast 301 being sent. There currently exists standards and technology for sending metadata 307 along with radio broadcasts 301, any of which may be suitable. This technology allows stations 303 to transmit additional types of information (i.e., metadata 307) via encoded digital signals that can be received by the user's radio 305. For instance, a radio 305 having technology compatible with such a standard can display the title and artist 309 for the current song playing, local traffic information, or an advertiser's phone number while a commercial is playing, etc. As an example, two such standards and technologies that enable providing such information are Radio Data System (RDS) and Radio Broadcast Data System (RBDS).

Radio Data System, or RDS, is a standard from the European Broadcasting Union (EBU) for sending small amounts of digital information using conventional FM radio broadcasts 301. The RDS system standardizes several types of information transmitted, including time and station identification. RDS has been a standard in Europe since the early 90s, but less so in North America.

Radio Broadcast Data System (RBDS) is the official name used for the U.S. version of RDS, though the “RDS” name seems to be at least as common in usage. The two standards are nearly identical, with only slight differences, mainly in which numbers are assigned to each of 31 musical and other program formats the RBDS system can identify. RBDS was approved by the National Radio Systems Committee (NRSC), RDS by the EBU.

Both use a 57 kHz subcarrier to carry data 307 at 1187.5 bits per second. The 57 kHz was chosen for being the third harmonic (3×) of the pilot tone for FM stereo, so it would not cause interference or intermodulation with it, or with the stereo difference signal at 38 kHz (2×). The data format utilizes error correction. RDS defines many features (see below), including how private (in-house) or other undefined features can be “packaged” in unused program groups.

The following information fields are normally contained in the RDS data:

AF, Alternate frequencies. This allows a receiver to re-tune to a different frequency providing the same station when the first signal becomes too weak (e.g. when moving out of range). This is often utilized in car stereo systems.

CT, Clock Time. Can synchronizes a clock in the receiver or the main clock in a car.

EON, Enhanced Other Networks. Allows the receiver to monitor other stations for traffic broadcasts.

PI, Program Identification. This is the unique code that identify the station. Every station receives a specific code with a country prefix.

PS, Program Service. This is simply an eight-character static display that represents the call letters or station identity name. Most RDS capable receivers display this information and, if the station is stored in the receiver's presets, will cache this information with the frequency and other details associated with that preset.

PTY, Program Type. This coding of up to 31 pre-defined program types—e.g. (in Europe): PTY1 News, PTY6 Drama, PTY11 Rock music—allows users to find similar programming by genre. PTY31 seems to be reserved for emergency announcements in the event of natural disasters or other major calamities.

REG, Regional links. This is mainly used in countries where national broadcasters run “region-specific” programming such as regional opt-outs on some of their transmitters. This functionality allows the user to “lock-down” the set to their current region or let the radio tune into other region-specific programming as they move into the other region.

RT, Radio Text, Radiotekst. This function allows a radio station to transmit free-form textual information that can be either static e.g. station slogans or in sync with the programming such as the title and artist of the currently-playing song.

TA, TP, Travel announcements, Traffic Program. The receiver can often be set to pay special attention to this flag and ,e.g., stop the tape or retune to receive a Traffic bulletin. The TP flag is used to allow the user to find only those stations that regularly broadcast traffic bulletins whereas the TA flag is used to stop the tape or raise the volume during a traffic bulletin.

TMC, Traffic Message Channel. Demands a RDS-TMC decoder.

As far as implementation is concerned, most car sets will support at least AF, EON, REG, PS and TA/TP. More expensive car sets will offer TMC, RT and/or PTY, perhaps with “NEWS” override. Home sets, especially hi-fi sets, will mainly support functions like PS, RT and PTY. There have been few implementations of RDS in portable, tabletop and personal (Walkman) radios because most of these sets are made to a price-point and the cost to implement RDS in these sets would place the sets beyond that price point, which may explain the high price of the RDS-equipped iPod® Radio Remote, which allows 5th generation iPod® owners to listen to FM radio. If RDS is implemented in these sets, they would at least support PS, RT, PTY and/or CT.

The following table lists the RDS and RBDS Program Type codes and their meanings:

| PTY code | RDS Proram type | RBDS Program type |
|---|---|---|
| 0 | No program type or undefined | No program type or undefined |
| 1 | News | News |
| 2 | Current affairs | Information |
| 3 | Information | Sports |
| 4 | Sport | Talk |
| 5 | Education | Rock |
| 6 | Drama | Classic Rock |
| 7 | Culture | Adult Hits |
| 8 | Science | Soft Rock |
| 9 | Varied | Top 40 |
| 10 | Pop Music | Country |
| 11 | Rock Music | Oldies |
| 12 | M.O.R. Music | Soft |
| 13 | Light classical | Nostalgia |
| 14 | Serious classical | Jazz |
| 15 | Other Music | Classical |
| 16 | Weather | Rhythm and Blues |
| 17 | Finance | Soft Rhythm and Blues |
| 18 | Children's programmes | Language |
| 19 | Social Affairs | Religious Music |
| 20 | Religion | Religious Talk |
| 21 | Phone In | Personality |
| 22 | Travel | Public |
| 23 | Leisure | College |
| 24 | Jazz Music | Unassigned |
| 25 | Country Music | Unassigned |
| 26 | National Music | Unassigned |
| 27 | Oldies Music | Unassigned |
| 28 | Folk Music | Unassigned |
| 29 | Documentary | Weather |
| 30 | Alarm Test | Emergency Test |
| 31 | Alarm | Emergency |

However, among others, any method, system, procedure or technology that allows stations to transmit additional types of information (i.e., metadata) via encoded digital signals that can be received by the user's radio is suitable. Also, among others, any frequency and type of broadcast that allows stations to transmit additional types of information (i.e., metadata) via encoded digital or analog signals that can be received by the user's radio is suitable. Examples may include, FM, AM, satellite broadcasts, shortwave radio, microwave, cellular phone frequencies and broadcasts, etc. Also, the radio 305 may be an automobile radio, for example, or any other type of radio, be it portable or not, having technology to receive the additional types of information (i.e., metadata) via encoded digital or analog signals.

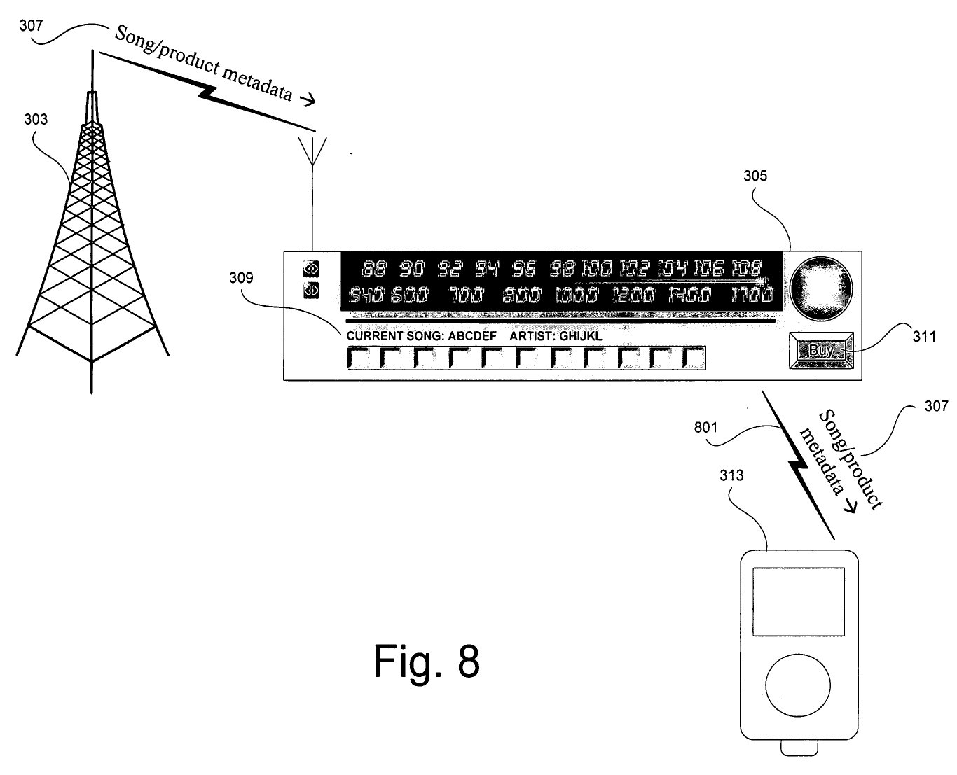

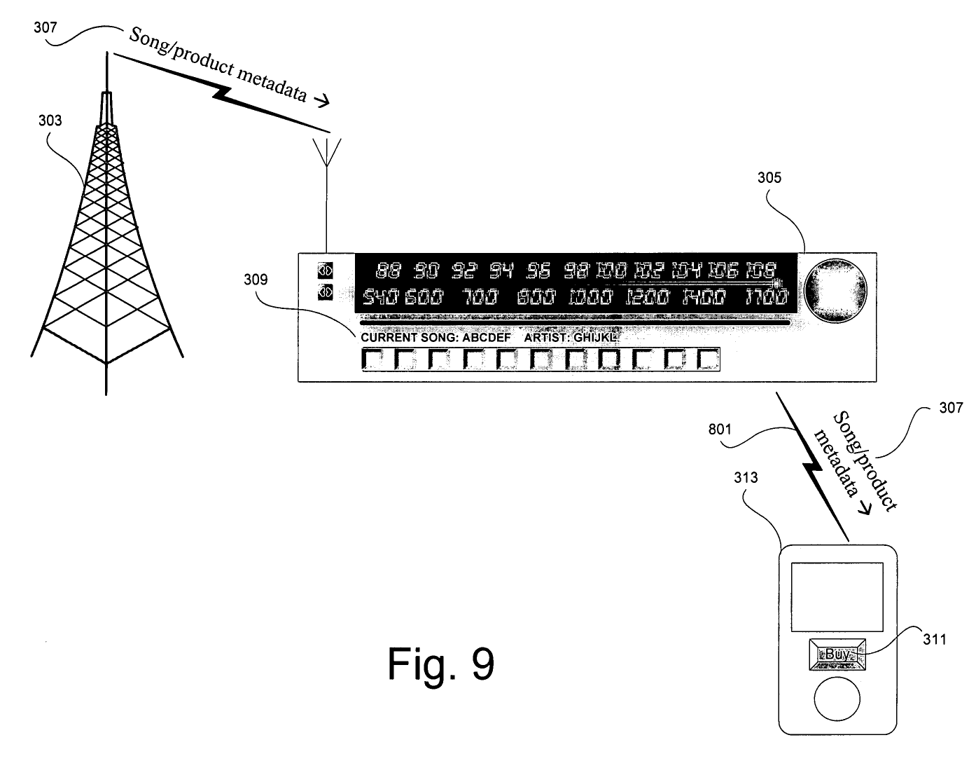

Some or all of the metadata 307 associated with the current broadcast 301 is stored temporarily, for example, in a buffer memory such as that RAM memory 222 shown in FIG. 1, within the radio 305 or within a portable computing device (device) 313 connected to the radio 315. The radio 305 is equipped with a selection means such as a button 311, for example, that when activated by a listener triggers the metadata 307, if any, associated with the particular current broadcast 301 to be stored in a list in memory on the device 313. For example, RT (Radio Text, Radiotekst) information field of the RDS system as described above may carry information 307 (e.g., the title of the song currently being broadcast, or information identifying a product associated with the commercial currently being broadcast, etc.). This information is then stored or logged in a list in memory on the device 313. This metadata 307 is communicated over a connection 315 between the radio 305 and the device 313. This connection may be a physical cable connection through a Universal Serial Bus (USB) interface, Firewire® interface, for example, or via a short range wireless connection (See FIG. 8), such as Bluetooth®. However, the particular wired or wireless interface and connection may vary as long as it provides a suitable medium to communicate the metadata 307 to the device 313. Also, the selection means 311 need not be a button, but can be any means that the listener can activate while listening to the broadcast 301 to indicate that he or she wishes to purchase or acquire the song, product, or information associated with the current broadcast 301. For example, the selection means may include, but is not limited to: a button, switch, lever, mouse button, voice activated selection means, touchscreen selection means, remote control, a selection means located on the portable computing device (see FIG. 9), or selection means located anywhere within the interior of an automobile connected by wire or wirelessly to the radio 305. Herein “connected” or connection” means connection via a cable, wireless or a combination of both.

For example, when a particular song is playing on the radio 305 via the broadcast 301, the listener may select to purchase the currently playing song by pushing the button 311 while the song is playing or shortly thereafter. The buffer in the radio 305 or connected device 313, for example, will hold the metadata associated with the current song or advertisement and subsequent songs or advertisements until some designated point in the future. This can be, for example, until the song or advertisement is over, until the next song or advertisement starts, until the listener activates the selection means 311, until a particular number of songs or advertisements have passed, until the radio is turned off, until the listener responds to a prompt, etc. This will enable the listener to select songs or products for purchase associated with that stored metadata 307 well after the song or advertisement associated with that metadata has ended. There may also be additional selection means and/or prompts to select which, if any, of the songs or products associated with the stored metadata the listener whishes to acquire or purchase.

### Using the Acquired Song/Product Metadata

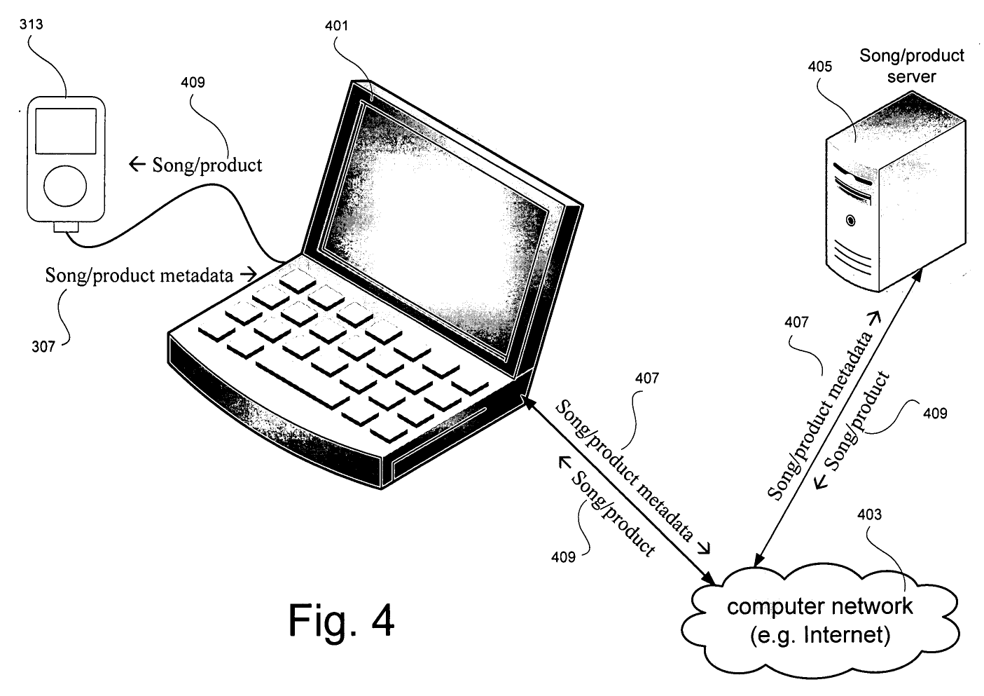

Referring next to both FIGS. 3 and 4, shown additionally in FIG. 4 is a diagram illustrating an example of a system for acquiring songs or products whose information was collected through radio broadcast. The device 313 is disconnected from the radio 305 (see FIG. 3). The device 313 has stored thereon a list comprising metadata 307 associated with at least one song or product that was associated with a particular radio broadcast 301. The list was created, for example, as a result of the listener selecting the song being broadcasted, or product associated with a current broadcast, by activating a selection means 311 such as a button during the broadcast 301. Metadata 307 encoded in the broadcast signal 301 associated with the current song being played or current broadcast is added to the list when the selection means 311 is activated by the listener.

When the device 313 is connected to the computer 401, the list of metadata 307 is used by the computer 401 to download or place an order 407 over a computer network 403 (e.g., the Internet) for the songs or products associated with each item in the list of metadata 307. This may be accomplished via software loaded on the device 313 and/or the computer 401 that takes the metadata 307 and performs searches 407 for particular songs and/or products associated with and/or identified by the items in the list of metadata 307. These searches 407 may, for example, be for items that are located remotely on sever(s) 405 accessible through the computer network 403. One example is that these searches are performed using an Internet search engine with an Internet browser, or through software that connects over the Internet 403 to specific retail server(s) 405 that may have software compatible with or adapted to communicate with corresponding client software loaded on the device 313 and/or computer 401. If the songs and/or products are available, an order is placed for the songs/and or products, or they are automatically downloaded 409 to the device and/or computer 401 via the computer 401 and song/product server 405 through the computer network 403. As an example, the products may include, but are not limited to: songs, videos, multimedia products, information, articles of manufacture, clothing, books, food, animals, etc. If the product is in digital format (e.g., digital video, audio, text, images), it may be downloaded from the server(s) 405 over the computer network 403. However, if the product is not able to be downloaded (e.g., file size is too large, hard copy of a book, article of manufacture), an order may be placed for the product over the computer network 403 and it can be mailed to the listener. In order to streamline and standardize the process of identifying the items to be acquired associated with the metadata 307, the metadata 307 that is broadcast 301 may comprise a unique identifier or serial number of a particular song or product associated with the current broadcast 301. This unique identifier is then sent 407 by computer 401 to the server(s) 405 or translated into another suitable identifier and then sent 407. It can then be immediately determined whether the song and/or product is available without performing extensive searching or going through a lengthy identification process (e.g., eliminating duplicate song titles, etc.). The software loaded on the device and/or computer to manage the process of acquiring the songs/and or products may include a variety of features and graphical interfaces to empower the listener to have more or less choices and/or control with respect to the acquisition process. For example, a listener may wish to narrow down the number of selections before they are automatically downloaded after connecting the device 313. The software on the device 313 and/or computer 401 may prompt the listener or present the listener the list of items to be downloaded so that they may eliminate or add selections before the downloading and/or purchasing process begins. Also, the software on the device 313 and/or computer 401 may provide the results of which songs and/or products are actually available before and/or after downloading or ordering them. However, these are only examples and a myriad of other options may be made to the listener via the software loaded on the device 313 and/or computer 401. Once the songs and/or products 409 are downloaded on the portable computing device 313 and/or computer 401, the listener can then enjoy them at his or her leisure. For example, when the user re-connects the portable computing device 313 to his or her car stereo 305, the songs that the user previously selected by pushing the “buy” button 311 will be available to play off of the portable computing device 313 through the car stereo 305.

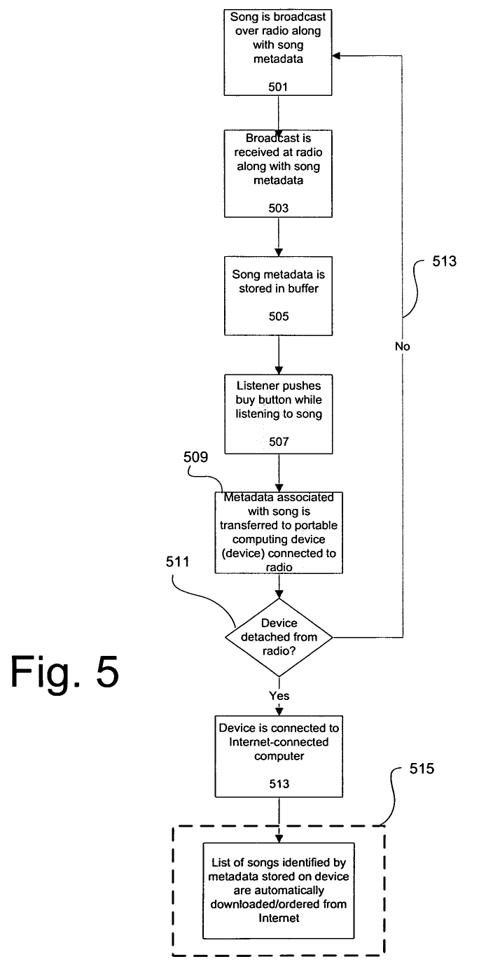

Referring next to FIG. 5, shown is a diagram illustrating an example of a process for acquiring songs whose information was collected through radio broadcast. First, the song is broadcast 501 over radio along with song metadata 307. Then the broadcast 301 is received 503 at the radio 305 along with the song metadata 307. The song metadata 307 is then stored 505 in a memory buffer located within the radio 305 or the portable computing device 313 connected to the radio 305. During the song broadcast, the listener pushes 507 a buy button 311 (or other selection means). At this point, there may also be some translation or conversion of the metadata 307 to an appropriate format to use for automatically searching or locating over the Internet 403 the product associated with the metadata 307. This may be performed by the radio 305 or device 313 before or after the metadata 307 is moved or copied 509. The metadata 307 associated with or identifying the song is then moved or copied 509 from the memory buffer to the to portable computing device (device) 313 connected to radio 305. Alternatively, the buffer may continue to store metadata 307 of selected songs and then move or copy all or some of the metadata to the device 313 at some later point when the device 313 is connected to the radio 305. For example, the listener may wish to delete some song selections before disconnecting the device 313 from the radio 305. Thus, there may be an option for the user to delete the selections from the buffer, prior to the song metadata being moved or copied to the device 313.

Until the device 313 is disconnected or detached from the radio (or until the song selection feature is otherwise disabled) 511, the above process may repeat 513 for songs or products, resulting in a list of song and/or product metadata 307 being stored on the device 313. After the device 313 is disconnected 511 from the radio 305, it is connected 517 to a computer 401 that is or will be connected to a computer network such as the Internet 403, for example. The list of songs and/or products identified by the metadata 307 stored on the device 313 are then automatically downloaded/ordered 515 from a computer network such as the Internet, for example. The downloading/ordering 515 may also occur not automatically. For example, at the option of the user, there may be some human interaction required such as verification of song and/or product selections or titles before the downloading or ordering takes place.

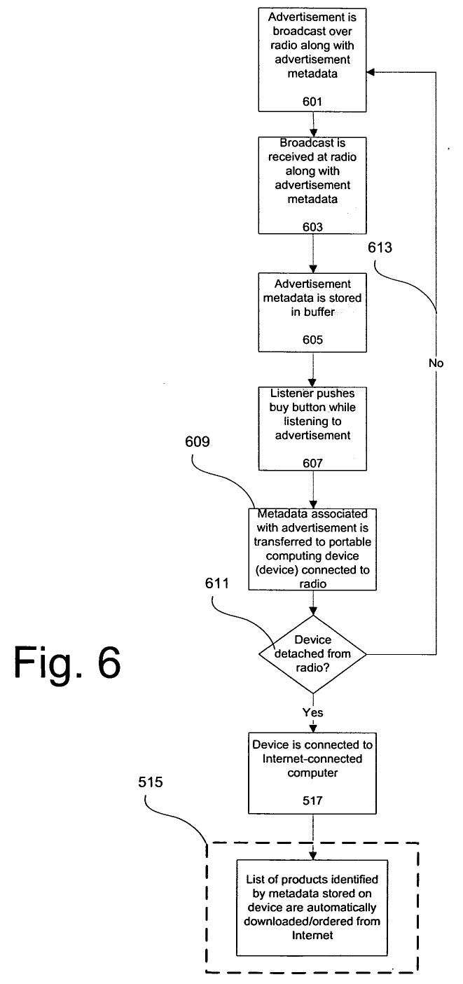

Referring next to FIG. 6, shown is a diagram illustrating an example process for acquiring products associated with an advertisement whose information was collected through radio broadcast. First, the advertisement is broadcast 501 over radio along with song metadata 307. Then the broadcast 301 is received 603 at the radio 305 along with the advertisement metadata 307. The advertisement metadata 307 is then stored 605 in a memory buffer located within the radio 305 or the portable computing device 313 connected to the radio 305. During the advertisement broadcast, the listener pushes 607 a buy button 311 (or other selection means). At this point, there may also be some translation or conversion of the metadata 307 to an appropriate format to use for automatically searching or locating over the Internet 403 the product associated with the metadata 307. This may be performed by the radio 305 or device 313 before or after the metadata 307 is moved or copied 609. The metadata 307 associated with or identifying the product associated with the advertisement is then moved or copied 609 from the memory buffer to the to portable computing device (device) 313 connected to radio 305. Alternatively, The buffer may continue to store metadata 307 of selected products and then move or copy all or some of the metadata to the device 313 at some later point when the device 313 is connected to the radio 305. For example, the listener may wish to delete some product selections before disconnecting the device 313 from the radio 305. Thus, there may be an option for the user to delete the selections from the buffer, prior to the product metadata 307 being moved or copied to the device 313.

Until the device 313 is disconnected or detached from the radio (or until the product selection feature is otherwise disabled) 611, the above process may repeat 613 for songs or products, resulting in a list of song and/or product metadata 307 being stored on the device 313. After the device 313 is disconnected 611 from the radio 305, it is connected 517 to a computer 401 that is or will be connected to a computer network such as the Internet 403, for example. The list of songs and/or products identified by the metadata 307 stored on the device 313 are then automatically downloaded/ordered 515 from a computer network such as the Internet, for example. The downloading/ordering 515 may also occur not automatically. For example, at the option of the user, there may be some human interaction required such as verification of song and/or product selections or titles before the downloading or ordering takes place.

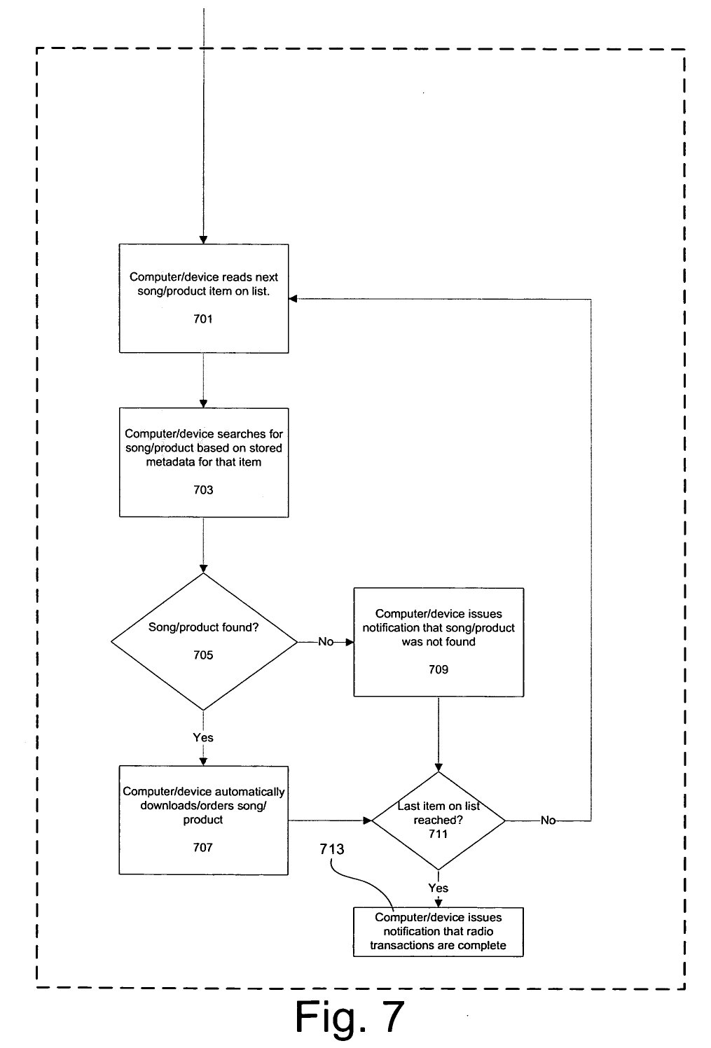

Referring next to FIG. 7, shown is a diagram illustrating a more detailed example process 515 for ordering or downloading songs or products whose information was collected through radio broadcast and stored in a list.

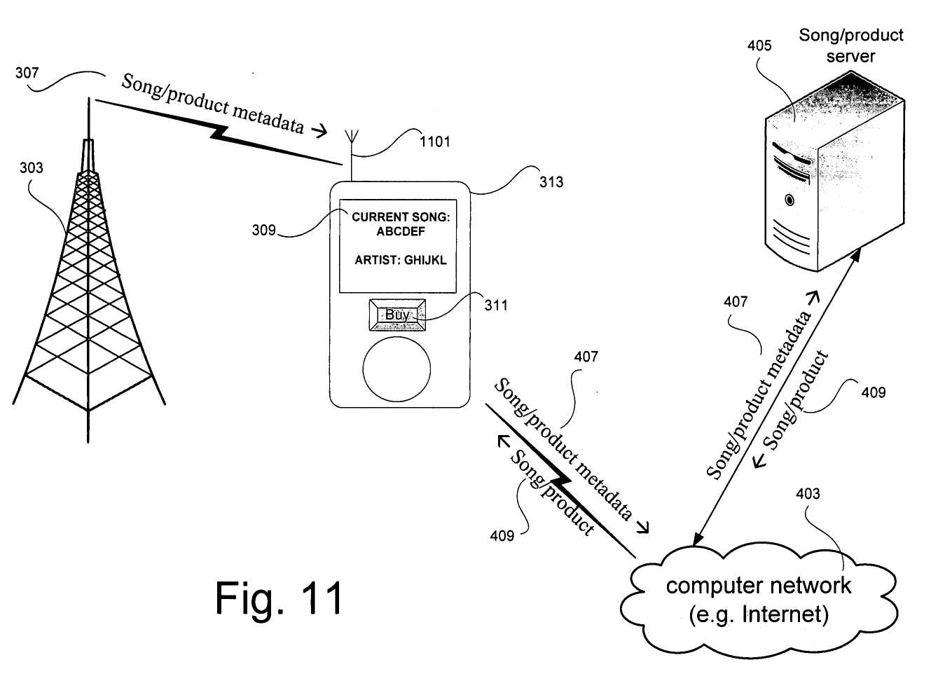

After the device 313 is connected 513 to the Internet-connected computer or device 401, as shown in FIGS. 4-6, for example, or if the device 313 itself is connected to the Internet 403 (see FIG. 11) the computer 401/device 313 reads 701 the metadata associated with or identifying the next song or product item on the list of stored metadata (starting with the first item on the list). The computer 401/device 313 then searches for the song/product based on the stored metadata for that item. This may occur automatically. If the song/product is found 705, then the computer 401/device 313 downloads 707 or orders the song or product for the user. This may also occur automatically. If the song/product is not found 705, the computer 401/device 313 issues notification that song/product was not found or is not available. The above process repeats 715 until the last item on the list is reached 711, and then the computer 401/device 313 issues 713 a notification that the radio transactions are complete. The above process may also be tied in with the automatic charging of the user for the items downloaded or ordered. Also, the items downloaded may be downloaded to the computer 401, device 313, or both, which also may occur automatically.

Referring next to FIG. 8, shown is a diagram illustrating an example of a system for collecting information broadcast over the radio with a portable computing device connected wirelessly to the radio. The processes described above may be performed over a wireless connection 801 as shown in FIG. 8.

Referring next to FIG. 9, shown is a diagram illustrating an example of a system for collecting information broadcast over the radio wherein a portable computing device having a buy button is connected wirelessly to the radio. The processes described above may be performed using a selection means located other than on the radio 305, such as a selection means of a buy button 311 located on the device 313 as shown in FIG. 9, for example.

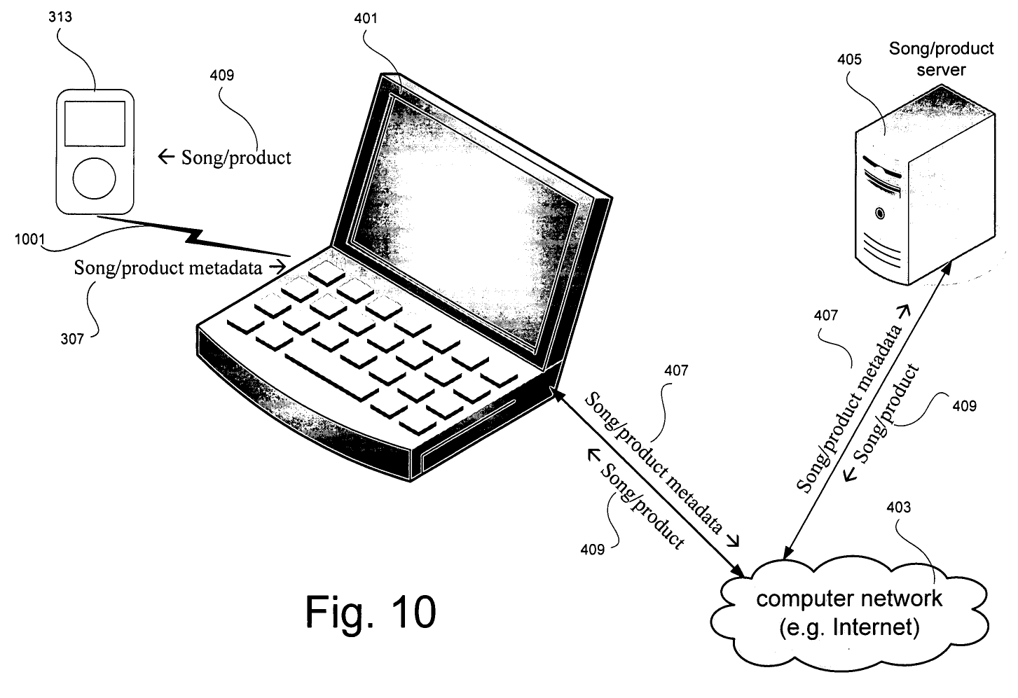

Referring next to FIG. 10, shown is a diagram illustrating an example of a system for acquiring songs or products whose information was collected through radio broadcast wherein a portable computing device is wirelessly connected to a computer. The processes described above may be performed over a wireless connection 1001 as shown in FIG. 10.

Referring next to FIG. 11, shown is a diagram illustrating an example of a system for acquiring songs or products associated with radio broadcasts. Shown is the portable computing device having an integrated radio receiver 1101 receiving a radio broadcast including son/product metadata. The device is also connected to the Internet (in this case through a wireless connection 1103 as well, for example).

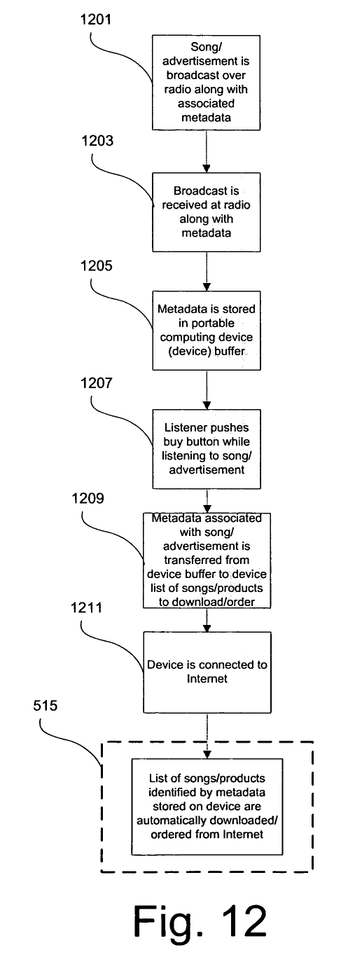

Referring next to FIG. 12, shown is a diagram illustrating an example process for acquiring songs or products associated with radio broadcasts using a system such as that shown in FIG. 11. First, the song/advertisement is broadcast 1201 over radio along with associated metadata. Then the broadcast is received 1203 at the radio receiver of the portable computing device along with the metadata (such as the radio of the portable computing device 313 shown in FIG. 11, for example). The metadata is then stored 1205 in the portable computing device (device) buffer. The listener pushes a buy button 1207 or activates some other selection means via the portable computing device while listening to a song, program or advertisement on the portable computing device radio. The metadata associated with the song/advertisement is moved or copied 1209 from the device buffer to device list of songs/products to download or order. However, this step may be skipped if the buffer and the stored list are one and the same. The device is then connected to the internet 1211 (if not already) and the list of songs/products identified by metadata stored on device are downloaded/ordered 515 from Internet. If the device 313 is already connected to the Internet, then the songs/products identified by metadata stored on the device 313 may be immediately downloaded/ordered from Internet when the listener pushes a buy button 1207 or activates some other selection means via the portable computing device.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the functionality of the present invention.

While the present invention has been described in connection with the preferred embodiments of the various figures, it is to be understood that other similar embodiments may be used or modifications and additions may be made to the described embodiment for performing the same function of the present invention without deviating there from. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

Finally, the disclosed embodiments described herein may be adapted for use in other processor architectures, computer-based systems, or system virtualizations, and such embodiments are expressly anticipated by the disclosures made herein and, thus, the present invention should not be limited to specific embodiments described herein but instead construed most broadly.

What is claimed:

1. A system for acquiring songs or products associated with radio broadcasts comprising:
means for indicating a selection of a product identified by metadata, the metadata included in a received radio broadcast; and
means for communicating to a computing device, triggered by said indicating a selection, the metadata identifying the product, said communicating enabling subsequent downloading or ordering of the product over a computer network using the metadata communicated to the computing device.

2. The system of claim 1 wherein the computing device has an integrated radio operable for receiving the broadcast and included metadata.

3. The method of claim 1 wherein the computing device is a portable computing device connected to a radio, said radio operable for receiving the broadcast and included metadata.

4. The system of claim 1 wherein the portable computing device comprises functionality such that the device initiates a downloading or ordering process of the product using the metadata communicated to the computing device.

5. The system of claim 1 wherein the product is a song.

6. The system of claim 1 wherein the broadcast is an FM radio broadcast.

7. The system of claim 1 wherein the means for indicating a selection comprises:
a button located on a radio device, said button operable for selecting products during said broadcast identified by the metadata included in the broadcast.

8. A method for acquiring songs or products associated with radio broadcasts comprising:
providing means for indicating a selection of a product identified by metadata, the metadata included in a received radio broadcast; and
providing means for communicating to a computing device, triggered by said indicating a selection, the metadata identifying the product, said communicating enabling subsequent downloading or ordering of the product over a computer network using the metadata communicated to the computing device.

9. The method of claim 1 wherein the computing device has an integrated radio operable for receiving the broadcast and included metadata.

10. The method of claim 1 wherein the computing device is a portable computing device connected to a radio that is operable for receiving the broadcast and included metadata.

11. The method of claim 1 wherein the portable computing device comprises functionality such that the device initiates a downloading or ordering process of the product using the communicated metadata.

12. The method of claim 1 wherein the product is a song.

13. The method of claim 1 wherein the broadcast is an FM radio broadcast.

14. The method of claim 1 wherein the providing means for indicating a selection comprises:
providing a button located on a radio device such that during the broadcast, said button may be pushed during the broadcast for selecting products identified by the metadata included in the broadcast.

15. A computer readable medium having computer executable instructions thereon for enabling the performance of the method of claim 8.

16. A computer readable medium having computer executable instructions thereon for enabling the performance of the method of claim 9.

17. A computer readable medium having computer executable instructions thereon for enabling the performance of the method of claim 10.

18. A computer readable medium having computer executable instructions thereon for enabling the performance of the method of claim 11.

19. A computer readable medium having computer executable instructions thereon for enabling the performance of the method of claim 12.

20. A computer readable medium having computer executable instructions thereon for enabling the performance of the method of claim 13.

21. A computer readable medium having computer executable instructions thereon for enabling the performance of the method of claim 14.

22. A device for acquiring songs or products associated with radio broadcasts comprising:
a memory that stores, triggered by an indication of a product selection, metadata included in a radio broadcast identifying the product; and
a module that enables a downloading or ordering process for the product over a computer network using the stored metadata.

23. The device of claim 23 further comprising a means for indicating a selection of a product identified by metadata included in a received radio broadcast.
